(19) United States
(12) Patent Application Publication
(10) Pub. No.: US 2015/0192361 A1
(43) Pub. Date: Jul. 9, 2015

(54) CLEANING ASSEMBLY FOR A SCREENED DRYER

(71) Applicant: SUKUP MANUFACTURING CO., Sheffield, IA (US)

(72) Inventor: Eugene G. Sukup, Hampton, IA (US)

(21) Appl. No.: 14/593,377

(22) Filed: Jan. 9, 2015

Related U.S. Application Data
(60) Provisional application No. 61/925,419, filed on Jan. 9, 2014.

(51) Int. Cl. F26B 17/12

(52) U.S. Cl. CPC F26B 17/122

(57) ABSTRACT

A cleaning assembly for a screened dryer includes a gear motor mounted to a dryer. A drive shaft is connected to and extends away from the gear motor and is mounted to the dryer. At least one and preferably a plurality of drive sprockets are connected to the drive shaft. A continuous chain is attached about the drive sprocket and an idler sprocket. The chain carries at least one wiper that engages a top wall of the dryer.

### CROSS REFERENCE TO RELATED APPLICATION

This application claims the benefit of U.S. Provisional Application No. 61/925,419 filed Jan. 9, 2014.

### BACKGROUND OF THE INVENTION

The invention is directed to a cleaning assembly and more particularly a cleaning assembly for removing grain fragments and particulate matter from a screened dryer.

Screened dryers are well known in the art. During operation, dust, grain fragments, and particulate matter are deposited on a top inclined wall of the screened dryers. These deposits reduce the airflow in the dryer which also reduces capacity and efficiency. Presently to remove these deposits, an operator manually cleans with a broom or a power washer which is time consuming and labor intensive. Therefore, there exists a need for a device that addresses these deficiencies.

An objective of the present invention is to provide a cleaning assembly that automatically removes deposits from a screened dryer.

Another objective of the present invention is to provide a cleaning assembly that improves the capacity and efficiency of a screened dryer.

These and other objectives will be apparent to one skilled in the art based upon the following written description, drawings, and claims.

### SUMMARY OF THE INVENTION

A cleaning assembly for a screened dryer includes a gear motor mounted to a dryer. A drive shaft is connected to and extends away from the gear motor and is mounted to the dryer. At least one and preferably a plurality of drive sprockets are connected to the drive shaft. A continuous chain is attached about the drive sprocket and an idler sprocket. The chain carries at least one wiper that engages a top wall of the dryer.

### BRIEF DESCRIPTION OF THE DRAWINGS

FIG. 1 is an enlarged perspective view of a cleaning assembly for a screened dryer;

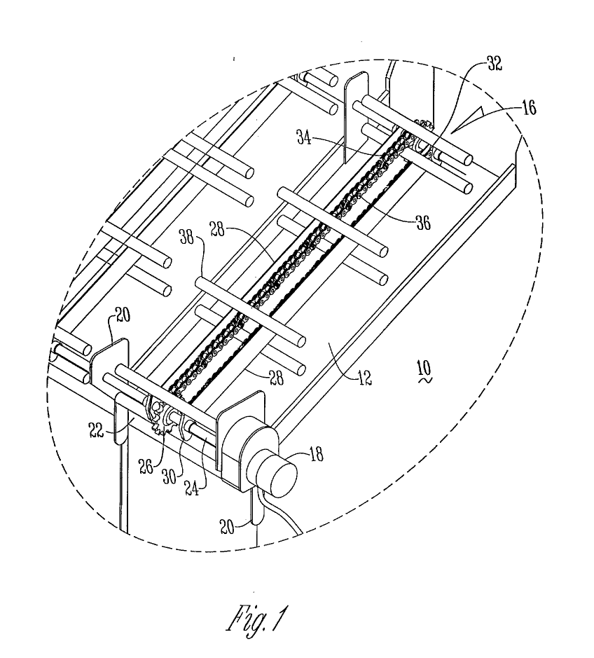

FIG. 2 is a perspective view of a screened dryer having a cleaning assembly; and

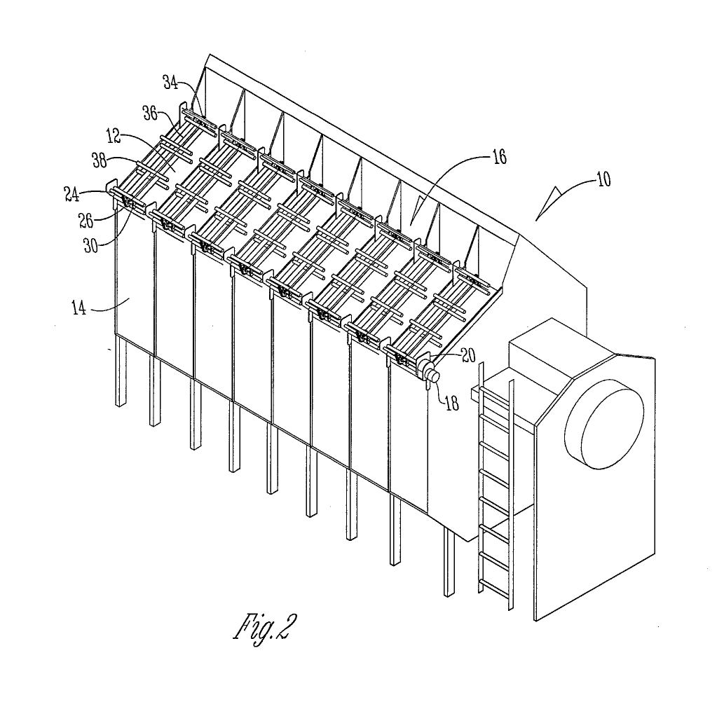

FIG. 3 is an end view of a screened dryer having a cleaning assembly.

### DETAILED DESCRIPTION OF THE PREFERRED EMBODIMENTS

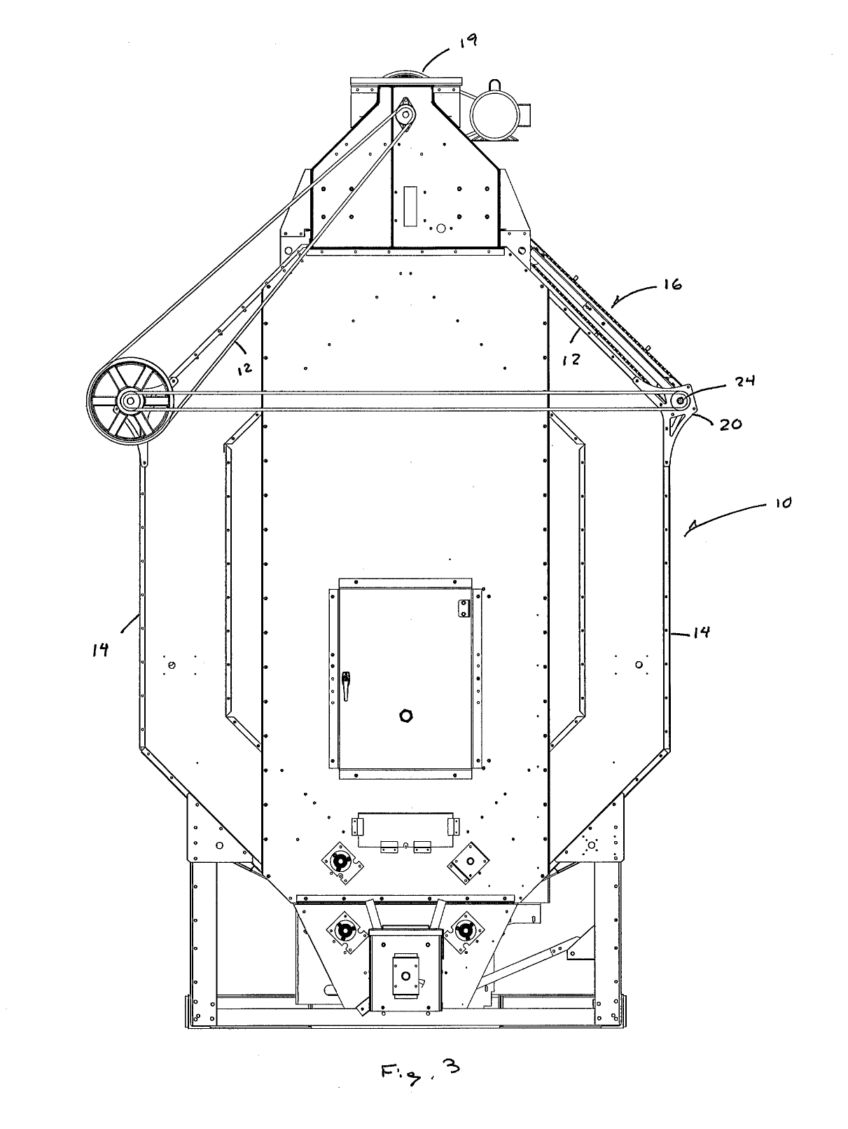

Referring to the Figures, a screened dryer 10 for drying grain has a top inclined wall 12, and a sidewall 14. Mounted to the screened dryer 10 is at least one and preferably two cleaning assemblies 16 on opposite inclined walls. The cleaning assembly 16 includes a gear motor 18 connected to the dryer 10 by a bracket 20 or the like. Alternatively, more than one motor 18 may be used and/or the motor 18 is remote from assembly 16. Also, as an example, a single motor 18 is connected to multiple assemblies 16 by a chain or the like or a fill auger 19 is operatively connected to the assembly 16, as shown by example in FIG. 3.

Extending outwardly from the gear motor 18 adjacent a lower end 22 of the inclined wall 12 of the dryer 10 is a drive shaft 24. The drive shaft 24 is mounted to the dryer 10 by a plurality of brackets 20. Mounted to the drive shaft 24 in spaced relation are a plurality of drive sprockets 26. On both sides of the drive sprocket 26 are a pair of support arms 28 that are attached to the drive shaft 24 at a first end 30 and extend upwardly in parallel spaced relation to the inclined wall 12 of the dryer 10.

Rotatably connected to a second end 32 of the support arms 28 are idler sprockets 34. The idler sprocket 34 and drive sprocket 26 support a continuous chain 36 mounted thereto. Connected to the chain 36 are a plurality of spaced apart wipers 38. The wipers 38 are of any size or shape such as a brush or a blade. Preferably the wipers 38 are UHMW poly blades. Alternatively, a single wiper 38 is used.

In operation, the gear motor 18 acts upon the drive shaft 24 causing the drive shaft 24 to rotate. The rotation of the drive shaft 24 causes the drive sprockets 26 to rotate which in turn causes the chain 36 to rotate about the drive sprocket 26 and the idler sprocket 34. The wipers 38, which are transverse to the chain 36, move along with the chain 36, around sprockets 26 and 34 such that the wipers 38 engage the inclined wall 12 of the dryer 10 to sweep or push dust, grain fragments, and/or particulate matter off the inclined wall.

Alternatively, a controller 40 is connected to the gear motor 18. The controller 40 acts upon the gear motor 18 to reverse the rotation of the drive shaft 24. As a result, the wipers 38 oscillate back and forth in relation to the top wall 12 of the dryer 10.

Accordingly, a cleaning assembly for a screened dryer has been disclosed that, at the very least, meets all the stated objectives.

What is claimed is:

1. A cleaning assembly for a screened dryer, comprising:
a gear motor mounted to the screened dryer;
a drive shaft connected to the gear motor and mounted to the screened dryer;
at least one drive sprocket connected to the drive shaft;
a continuous chain mounted about the drive sprocket and an idler sprocket; and
at least one wiper attached to the chain.

2. The cleaning assembly of claim 1 further comprising a pair of support arms connected to the drive shaft at a first end and the at least one idler sprocket at the second end.

3. The cleaning assembly of claim 2 wherein the support arms extend upwardly in parallel spaced relation to a top inclined wall of the dryer such that the at least one wiper engages the top wall.

4. The cleaning assembly of claim 1 wherein the at least one wiper oscillates in relation the dryer.
